(19) United States
(12) Patent Application Publication
(10) Pub. No.: US 2005/0010013 A1
(43) Pub. Date: Jan. 13, 2005

(54) Cold curable isocyanate adhesives with reduced foaming

(76) Inventors: Joseph J. Marcinko, Mullica Hill, NJ (US); Anthony A. Parker, Newtown, PA (US); Paula Y. Teachey, Burlington Township, NJ (US); Chris J. Watt, Veazie, ME (US)

Correspondence Address: Patent Counsel;Huntsman Polyurethanes, 286 Mantua Grove Road, West Deptford, NJ, 08066-1732, US

(21) Appl. No.: 10/912,313

(22) Filed: Aug. 5, 2004

Related U.S. Application Data
(63) Continuation of application No. PCT/US03/03867, filed on Feb. 6, 2003.
(60) Provisional application No. 60/355,508, filed on Feb. 7, 2002.

(51) Int. Cl. C08G 18/00; C08G 18/71; C08G 18/32; C08G 18/38; C08G 18/40

(52) U.S. Cl. 528/69; 528/74.5

(57) ABSTRACT

Moisture activated polyisocyanate adhesives comprising isocyanate terminated prepolymers that provide rapid curing at relatively low temperatures. The adhesives have reduced tendency toward foaming and exhibit excellent gap filling characteristics. The adhesive compositions are suitable for use as wood adhesives, and are especially suitable for engineered composite lumber applications.

### CROSS-REFERENCE TO RELATED APPLICATIONS

This application is a continuation of international application PCT/US03/03867, filed Feb. 6, 2003, and further claims priority to U.S. Provisional Application Ser. No. 60/355,508, filed Feb. 7, 2002.

### FIELD OF THE INVENTION

The present invention is directed to moisture-activated adhesive compositions, methods for their production, and uses thereof. More specifically, the present invention is directed to one-component moisture-activated polyisocyanate adhesive compositions that are suitable for cold curing.

### BACKGROUND OF THE INVENTION

Adhesives suitable for use in wood products that demonstrate a prolonged pot life and a fast cure rate have long been desirable. Such adhesives would be useful in the manufacture of plywood, chip board, fiberboard, laminated veneer lumber (LVL), and engineered composite lumber articles (such as wooden I-beams). However, these characteristics have proven to be difficult to obtain in simple one-component formulations.

One such class of adhesives that are described in the prior art are moisture activated adhesive compositions that are liquid isocyanate functional resins that comprise the reaction product of a monomeric polyisocyanate composition with an aliphatic tertiary amine-initiated polyether polyol having an ethylene oxide content of at least 1% (e.g. WO-9510555). Such polyisocyanate adhesives offer a good combination of pot life and rapid curing at relatively low temperatures. Unfortunately, these adhesives, as in the case of other isocyanate-based moisture curing adhesive compositions, have a tendency to foam during cure. The source of the foaming is the carbon dioxide released during the reaction of moisture with the free isocyanate groups in the adhesive. Although not wishing to be bound by theory, it is suspected that the foaming problems associated with such cold curing adhesives are simply due to the fact that the curing reaction is faster. Because CO₂ formation is an inherent characteristic of the polymerization of organic polyisocyanates in the presence of moisture, there is little that can be done to prevent it.

Foaming is undesirable in many kinds of adhesive applications, such as, for example, in the production of engineered lumber articles such as I-beams or in the lamination of wood veneers. It may sometimes result in the excessive use of adhesive, and in costly post-processing of the bonded articles to remove cured adhesive “puffs” from the glue lines. Disposal of such waste may also be a consideration.

Therefore, there is a need for one component polyisocyanate adhesive compositions useful in the preparation of lumber replacements, such as laminated veneer lumber and engineered lumber articles, which fully cure at relatively low temperatures, e.g., room temperature. There is also a need for such adhesives that have a prolonged pot life suitable for use in commercial production methods. There is further a need for such one component adhesives that have a “gap filling” property, wherein the gap filling property is characterized by good flowability at relatively low viscosity under shear stress but with substantial absence of flow in the absence of shear stress. The adhesive should preferably become “fixed” in the absence of shear stress. There is a still further need for an adhesive having all these characteristics, and the additional characteristic of reduced tendency toward foaming during cure. Moreover, there is a need for processes for preparing composite products with cellulosic and lignocellulosic materials using such low-foaming adhesives.

### SUMMARY OF THE INVENTION

These objectives are obtained by the present adhesive compositions that demonstrate excellent adhesive properties with a prolonged pot life and fast cure, particularly at room temperature, and reduced tendency for foaming during cure relative to prior art adhesive compositions. The present compositions can be activated by the moisture present in the substrate with which they are being used, and thus, they may be most effectively used with substrates having a relatively high moisture content, such as 7% by weight or more.

The present compositions can be effectively used with various types of lignocellulosic materials and are particularly useful in the preparation of engineered lumber articles. The present adhesive compositions retain the advantages of prior art compositions in that they are cold curable. They are suitable for curing at room temperature, but may also be cured by the application of heat if desired.

In one embodiment, the present invention is directed to moisture-activated polyisocyanate adhesive compositions comprising:
A) the isocyanate functional reaction product of:
   (i) a monomeric organic polyisocyanate, and
   (ii) an isocyanate-reactive component comprising at least one aliphatic tertiary amine-initiated polyether polyol having an ethylene oxide content of at least 1% by weight relative to the total weight of the aliphatic tertiary amine-initiated polyol;
B) an inert fatty ester compound containing at least 20 carbon atoms; and
C) a dispersed inert filler.
   The moisture-activated polyisocyanate adhesive has a reduced tendency toward foaming during the cure thereof, as compared to the same adhesive composition in the absence of an effective amount of components B and C. The inert fatty ester compound preferably comprises an aliphatic fatty ester having at least 30 carbon atoms, and more preferably a liquid aliphatic triglyceride oil. The dispersed inert filler preferably comprises inorganic particulate filler.

In another embodiment, the present invention is further directed to a process for bonding multiple substrates comprising: (1) applying to a surface of at least one substrate the moisture-activated adhesive composition described above; (2) contacting this surface of the substrate with a surface of a second substrate; (3) applying pressure to the contacted surfaces; and (4) causing the adhesive composition to cure and form an adhesive bond between the substrates.

In another embodiment, the invention is still further directed to articles bonded with the adhesive described above. Wood substrates are particularly preferred.

### DETAILED DESCRIPTION OF THE INVENTION

The adhesive compositions of the invention comprise from about 50 to about 95% by weight of the isocyanate functional reaction product (Component A). Preferably, Component A makes up from 55 to 90% by weight of the total adhesive composition, more preferably from 60 to 85% by weight, still more preferably 65 to 80%, even more preferably 70 to 80%, and most preferably 72 to 78% by weight of the total adhesive composition. The isocyanate functional reaction product is preferably a mixture of free unreacted monomeric polyfunctional isocyanate species and isocyanate terminated reaction products (prepolymers) formed from the reaction of monomeric polyisocyanate with the isocyanate reactive component.

The ingredients used to prepare Component A comprise about 99 to about 60%, preferably about 93 to about 65% and most preferably about 90 to about 70% by weight of the monomeric (or “base”) polyisocyanate component.

The term “polyisocyanate” in the context of the present invention is understood to encompass difunctional isocyanate species, higher functionality isocyanate species, and mixtures thereof. The term “base” polyisocyanate (or monomeric polyisocyanate) will be understood to refer to polyisocyanates that have not been modified by reaction with isocyanate reactive species to form prepolymers. This term does, however, encompass polyisocyanates that have been modified by various known self-condensation reactions of polyisocyanates, such as carbodiimide modification, uretonimine modification, and trimer (isocyanurate) modification, under the proviso that the modified polyisocyanate still contains free isocyanate groups available for further reaction.

Base polyisocyanates useful in the present invention are those having a number-average isocyanate functionality of 2.0 or greater, preferably greater than 2.1, more preferably greater than 2.3 and most preferably greater than 2.4. Useful base polyisocyanates should have a number average molecular weight of from about 100 to about 5000, preferably about 120 to about 1800, more preferably 150 to 1000, still more preferably 170 to 700, even more preferably 180 to 500, and most preferably 200 to 400. Preferably, at least 80 mole percent and more preferably greater than 95 mole percent of the isocyanate groups of the base polyisocyanate composition are bonded directly to aromatic rings.

Examples of polyisocyanates suitable for use as the base polyisocyanate include aromatic polyisocyanates such as p-phenylene diisocyanate; m-phenylene diisocyanate; 2,4-toluene diisocyanate; 2,6-toluene diisocyanate; naphthalene diisocyanates; dianisidine diisocyanate; polymethylene polyphenyl polyisocyanates; 2,4′-diphenylmethane diisocyanate (2,4′-MDI); 4,4′-diphenylmethane diisocyanate (4,4′-MDI); 2,2′-diphenylmethane diisocyanate (2,2′-MDI); 3,3′-dimethyl-4,4′-biphenylenediisocyanate; mixtures of these; and the like. Polymethylene polyphony polyisocyanates (MDI series polyisocyanates) having number averaged functionalities of greater than 2 are an especially preferred family of aromatic polyisocyanates for use as the base polyisocyanates in the present invention.

The MDI base polyisocyanates should more preferably have a combined 2,4′-MDI and 2,2′-MDI content of less than 18.0%, more preferably less than 10% and most preferably less than 5%. However, any MDI diisocyanate isomer composition is suitable for use as, or as part of, the base polyisocyanate composition according to the invention.

The MDI diisocyanate isomers, mixtures of these isomers with tri and higher functionality polymethylene polyphenyl polyisocyanates, the tri or higher functionality polymethylene polyphenyl polyisocyanates themselves, and non-prepolymer derivatives of MDI series polyisocyanates (such as the carbodiimide, uretonimine, and/or isocyanurate modified derivatives) are all examples of preferred polyisocyanates for use as the base polyisocyanate in the present invention.

The base polyisocyanate composition may, optionally, include minor amounts of aliphatic polyisocyanates. Suitable aliphatic polyisocyanates include isophorone diisocyanate; 1,6-hexamethylene diisocyanate; 1,4-cyclohexyl diisocyanate; saturated analogues of the above-mentioned aromatic polyisocyanates and mixtures thereof.

The base polyisocyanate component preferably comprises a polymeric polyisocyanate, and more preferably polymeric diphenylmethane diisocyanate (polymethylene polyphenyl polyisocyanate) species of functionality 3 or greater. Commercially available polymeric polyisocyanates of the MDI series include RUBINATE® M isocyanate, which is commercially available from Huntsman Polyurethanes.

The isocyanate functional reaction product, Component A, is formed from the reaction of a suitable base polyisocyanate composition with an isocyanate reactive composition, under conditions such that some of the isocyanate groups remain unreacted after the isocyanate reactive composition is consumed. Suitable isocyanate reactive compositions include polyols, for preparing the isocyanate terminated prepolymers. The polyols necessarily contain at least one aliphatic tertiary amine-initiated polyol having an ethylene oxide content of at least 1% by weight. Other types of polyols may optionally be used in combination with the aliphatic tertiary amine polyol.

The aliphatic tertiary amine polyol is at least one hydroxy functional compound having two or more organic —OH groups and at least one aliphatic tertiary amine-initiator group wherein the aliphatic amine-initiated polyol compound is characterized by having an ethylene oxide content of at least 1% by weight of the molecule. Mixtures of more than one such tertiary amine containing polyol compound may of course be used if desired. Preferably, the ethylene oxide content of the tertiary amine polyol is from about 1 to about 90%, preferably about 5 to about 60% and most preferably about 10 to about 40% by weight of the molecule. The aliphatic tertiary amine-initiated polyol provides an ethylene oxide content in Component A of about 0.01 to about 27% by weight, preferably about 0.35 to about 12% and most preferably about 1 to about 8% by weight of the total Component A.

The amine-initiated polyol may contain any amount of propylene oxide, which is consistent with these limits on the ethylene oxide content thereof. Suitable aliphatic tertiary amine-initiated polyols are the known alkoxylation products of amines or aminoalcohols having at least two active hydrogen atoms with ethylene oxide and/or propylene oxide. Suitable initiator molecules include: ammonia, ethylene diamine, hexamethylene diamine, methyl amine, isopropanolamine, diisopropanolamine, ethanolamine, diethanolamine, N-methyl diethanolamine, tetrahydroxyethyl ethylenediamine, mixtures of these initiators, and the like. The most suitable aliphatic tertiary amine-initiated polyols are those wherein the initiator comprises about 1 to about 18 and preferably about 1 to about 6 carbon atoms. Suitable aliphatic tertiary amine-initiated polyols have a number averaged molecular weight of about 1000 to about 10,000 and preferably 1500 to about 6000 and a number average OH functionality of about 1.8 to about 6.0, more preferably 2.0 to 6.0.

It has been found that the concentration of tertiary aliphatically bound amine nitrogen in the amine-initiated polyol is related to the effectiveness (i.e. fast cure rate) of the final adhesive composition. In general, the tertiary aliphatically bound amine nitrogen concentration in the final adhesive composition, due to the aliphatic amine-initiated polyol(s), should be about 0.002 to about 0.05 eqN/100 g, preferably about 0.005 to about 0.025 eqN/100 g, more preferably about 0.01 to about 0.02 eqN/100 g, and most preferably about 0.012 to about 0.016 eqN/100 g. The term “eqN” refers to the number of equivalents of tertiary aliphatic nitrogen contributed by the aliphatic amine initiated polyol(s), and the weight (100 g) is that of the final adhesive composition.

Preferred amine-initiated aliphatic polyether polyols include those prepared from ethylene diamine, triethylene tetramine and/or triethanolamine, as the initiators. The present compositions include the aliphatic tertiary amine-initiated polyol component, in an amount of about 1 to about 30%, preferably about 7 to about 20% and most preferably about 10 to about 20% by weight based upon the total amount of Component A of the adhesive composition.

In its most preferred form, the amine-initiated polyol is an ethylene diamine-initiated polyol containing ethylene oxide. Suitable ethylene diamine-initiated polyols are those having an ethylene oxide content of about 1 to about 90% by weight, preferably about 5 to about 60%, and most preferably about 10 to about 40% by weight of the polyol. The ethylene oxide content refers to the amount of ethylene oxide utilized in the preparation of the polyols as discussed above.

During production of the preferred amine initiated polyols, the ethylene oxide reacts with the initiator. The polyols should have a molecular weight in the range of 1500 to 5000. The most preferred amine initiated polyols are free of primary or secondary amine groups. Non-limiting examples of suitable ethylene diamine-initiated polyols useful in the present compositions include those of the following general formula:
(H[EO]y[PO]x)2N—CH2CH2-N([PO]x[EO]yH)2.
wherein x denotes the number of PO units in each polyether chain and has a value of from about 1.0 to about 29.0 on a number averaged basis, preferably about 4.0 to about 20 and most preferably about 4.0 to about 14 on a number averaged basis; and y denotes the number of EO units in each polyether chain and has a value of from about 1.0 to about 10.0 on a number averaged basis and preferably about 2.0 to about 4.0 on a number averaged basis. “EO” denotes a single oxyethyene unit in the polyether chain. “PO” denotes a single oxypropylene unit in the polyether chain. “N” is a nitrogen atom from the ethylene diamine initiator. Suitable ethylene diamine-initiated polyols are available commercially, such as the “SYNPERONIC T” series of polyols available from Uniqema. A particularly preferred example of this commercial series of polyols is SYNPERONIC T/304 polyol.

Although not wishing to be limited to theory, it is believed that the amine-initiated polyol remains inactive in the present adhesive composition until it comes into contact with the moisture in or on the substrate (i.e. wood). Once the amine-initiated polyol contacts the moisture, it is believed to promote the reaction between the polyisocyanate and water in the system, thus accelerating cure and adhesion. The result is that the present adhesives are relatively fast curing. Moreover, the adhesive remains on the surface of the substrate where it is most effective and can develop cold tack for processing.

Other polyols may optionally be used in combination with the amine-initiated polyol (described hereinabove) in the isocyanate reactive component used for forming Component A. It is generally preferred to include a non-amine containing polyol in addition to the amine-initiated polyol in forming Component A. It is preferred, however, that the ethylene oxide containing aliphatic amine-initiated polyether polyol comprise at least 10% by weight of the total isocyanate reactive component used in making Component A. It is more preferred that the ethylene oxide containing aliphatic amine-initiated polyether polyol comprise at least 25% by weight, still more preferably at least 30% by weight, even more preferably at least 40% by weight, and most preferably at least 50% by weight of the total isocyanate reactive component used in making Component A.

Examples of preferred optional additional polyols suitable for use in forming Component A include: (a) polyether polyols, thioether polyols, and/or hydrocarbon-based polyols having a molecular weight of from about 1000 to 3000 and a number average hydroxyl functionality of from about 1.9 to 4; and (b) polyester polyols having a molecular weight of 1000 or more and a number average hydroxyl functionality of from about 1.9 to 4.

A particularly preferred class of isocyanate-terminated prepolymers useful as Component A are MDI prepolymers which are the reaction product of an excess of polymeric MDI (as the “base” polyisocyanate) and one or more polyether polyols. The polyether polyols are preferably diols and/or triols, individually having hydroxy values of 25 to 120. The polyol composition should have a number average molecular weight in the range of about 1000 to 3000. Such prepolymers should generally have a free-NCO content of more than about 10%, preferably more than about 16% and most preferably about 16 to about 26%. As such, these preferred prepolymers contain some unreacted monomeric polyisocyanate species, in addition to the isocyanate group terminated prepolymer species themselves. The polyol composition used in forming Component A, of course, contains at least one amine initiated aliphatic polyether polyol as described above. Suitable prepolymers are those in which the stoichiometric ratio of isocyanate (NCO) to hydroxyl (OH) exceeds 1:1.

RUBINATE® M isocyanate, available from Huntsman Polyurethanes, is one example of a suitable polymeric MDI composition useful in the present invention. In other preferred embodiments, this polymeric MDI composition is combined with a minor amount of an MDI diisocyanate isomer or isomer mixture. An example of a preferred MDI diisocyanate composition useful for this purpose is 4,4′-MDI. Preferably, the base polyisocyanate component is a blend of polymeric MDI, such as RUBINATE® M isocyanate, and a pure MDI, such as 4,4′-MDI. Such blends have been found to provide improved penetration into lignocellulosic substrates and higher wood failure as opposed to glueline failure. A commercially available pure MDI product suitable for use in the present invention is RUBINATE® 44 isocyanate, available commercially from Huntsman Polyurethanes. These blends preferably contain a ratio of the above polymeric MDI to the above pure MDI product in the range of about 95:5 to 50:50 and preferably 60:40 to 80:20, by weight.

The compositions of Component A may optionally further comprise various non-isocyanate-reactive compounds having a catalytic function to improve cure rate. Examples of suitable catalysts are, for example, the non-isocyanate-reactive tertiary amine catalysts. By non-isocyanate-reactive it is meant that the optional catalytic species is free of active hydrogen groups in the molecule. The optional catalyst is therefore quite distinct structurally from the required amine-initiated polyols. Suitable non-reactive tertiary amine catalysts are available commercially as, for example, NIAX A-4 catalyst available commercially from OSI Specialties Division of Witco Corporation, and JEFFCAT® DMDEE catalyst available from Huntsman Petrochemical Corporation. Most preferably, the NIAX A-4 catalyst is used in the relatively slower cure systems. When used in Component A, the optional catalysts are present in an amount of from about 0.05 to about 2.0% parts by weight, preferably about 0.1 to about 1.0 parts by weight, and more preferably from about 0.25 to 0.7 parts by weight relative to the final total weight of Component A.

The present compositions for Component A may be prepared by simply mixing or blending the polyisocyanate component and the polyol component under suitable conditions to promote prepolymer formation, particularly if both components are liquids at 25° C. (as is preferably the case). No moisture should be allowed to enter the system. If one of the ingredients is a solid, that component should be fully dissolved in the other liquid component. In any event, the components may be mixed or blended by any means evident to one skilled in the art. The final Component A is preferably a liquid at 25° C., having a viscosity at 25° C. of less than 10,000 cps, and more preferably less than 5000 cps, at 25° C.

Examples of isocyanate functional prepolymer compositions suitable for use as Component A, and suitable method for their preparation, are those described in WO-9510555, the subject matter of which is incorporated herein by reference.

The adhesive compositions additionally contain a particulate filler. Conventional fillers, such as calcium carbonate, calcium oxide, clays, silica, silicates such as talc, and mixtures thereof are suitable for this purpose. The particulate filler should be of a particle size that does not readily result in the bulk separation of the filler from the dispersion on standing. The dispersion of the filler in the adhesive composition should be stable to bulk separation for at least long enough to permit the use of the adhesive, and preferably long enough to permit the storage of the adhesive without the need for continuous agitation thereof. It is preferred that the final polyisocyanate adhesive should be storage stable at 25° C., without agitation, for at least 24 hours, and more preferably at least 30 days, without bulk separation of the filler. The optimum average particle size needed to achieve the desired level of stability will depend upon the type of filler used.

The fillers are generally added to the composition and mechanically mixed. Greater detail on the preferred embodiments of how the final adhesive composition of the invention is mixed is provided in the Examples section below. Those skilled in the art will, however, appreciate many possible variations on the mixing procedure shown in the Examples. The fillers have also been found useful to hold the adhesive on the surface of the substrate to be treated, thereby providing for a gap filling effect. A preferred class of particulate fillers include talc and mixtures of talc with calcium oxide. The preferred average particle size (average particle diameter) for these types of fillers is in the range of from 0.5 micron to 6.0 microns, but is more preferably in the range of from 1.0 micron to 5.0 microns.

In a preferred embodiment, a minor amount by weight (relative to the total filler loading) of CaO is pre-mixed with the other fillers (which most preferably consist essentially of talc) as a drying agent. This drying CaO operation is preferably conducted before the fillers are combined with the isocyanate group-containing Component A. The talc/calcium oxide mixtures are particularly preferred because the calcium oxide serves as a drying agent, to remove any available water from the surface of the talc, and prevent if from reacting with the polyisocyanate groups in Component A. It is desirable that any filler used should be sufficiently free of available water so that the final adhesive composition remains sufficiently free of gels and of low enough viscosity to permit application of the final adhesive composition onto substrates. The amount of the particulate filler by weight relative to the final adhesive composition may vary considerably depending upon the types of particulate fillers used. Effective amounts of filler may extend from as little as 1% by weight to as much as 50% by weight, but is preferably in the range of about 2 to 30%, more preferably 5 to 25%, still more preferably 5 to 20%, even more preferably 10 to 20%, and most preferably 12 to 18% by weight of the total adhesive composition.

The adhesive compositions further include an inert fatty ester. The fatty ester may be a single compound or a mixture of such compounds, but is preferred to be predominantly aliphatic fatty esters by weight. More preferably, the inert fatty ester component is entirely aliphatic. By the term “inert”, as applied to the fatty ester component, it is meant that the fatty ester component is essentially free of molecular species containing groups reactive toward isocyanates under the conditions of blend preparation or storage of the blend. By “essentially free” it is meant that the fatty ester component contains less than 10% by weight, preferably less than 5% by weight, more preferably less than 3% by weight, still more preferably less than 2% by weight, even more preferably less than 1% by weight, most preferably less than 0.5%, and ideally less than 0.1% by weight of molecular species bearing functional groups reactive toward the base isocyanate under the conditions of blend preparation or storage. The fatty ester component should be substantially non-volatile. By the term “substantially non-volatile” it is meant that the fatty ester component is essentially free of compounds boiling lower than 200° C. at 1 atmosphere (1 bar) pressure. More preferably, the fatty ester is essentially free of compounds boiling lower than 250° C. at 1 atmosphere (1 bar) pressure. Still more preferably the fatty ester component is essentially free of compounds boiling lower than 300° C. at 1 atmosphere (1 bar) pressure. Even more preferably, the fatty ester component is essentially free of compounds boiling below 350° C. at 1 atmosphere (1 bar) pressure. Most preferably, the fatty ester component is essentially free of compounds boiling lower than 400° C. at 1 atmosphere (1 bar) pressure. By “essentially free” it is meant that the fatty ester component contains less than 10% by weight, preferably less than 5% by weight, more preferably less than 3% by weight, still more preferably less than 2% by weight, even more preferably less than 1% by weight, most preferably less than 0.5%, and ideally less than 0.1% by weight of compounds (molecular species) having boiling points lower than the boiling point indicated. The essential absence of low boiling species in the fatty ester component should result in a fatty ester component which is characterized by having its initial boiling point at 1 atmosphere (1 bar) pressure of at least 125° C., more preferably at least 150° C., still more preferably at least 180° C., even more preferably at least 200° C., and most preferably greater than 200° C. The fatty ester component should be soluble in the isocyanate containing Component A, and preferably miscible with Component A in all proportions at 25° C. The fatty ester component is preferably a liquid at 25° C. The fatty ester component preferably has a viscosity at 25° C. that is lower than that of Component A at 25° C. The fatty ester component comprises at least one fatty ester compound of 20 carbons or more, preferably of 30 carbons or more. The individual compounds present in the inert fatty ester component composition preferably contain at least 20 carbon atoms, and most preferably at least 30 carbon atoms.

A preferred class of compounds suitable for use in the fatty ester component compositions according to the invention are inert triglyceride oils. Other fatty ester compounds may optionally be used, either instead of or in addition to triglyceride oils. The triglyceride oils are preferably liquid at 25° C. and have viscosities lower than that of Component A at 25° C. The trigylceride oils preferably consist essentially of organic aliphatic molecular species having at least 33 carbon atoms and at least one triglyceride ester moiety. The more preferred triglyceride oils consist essentially of molecular species having greater than 50 carbon atoms. The more preferred triglyceride oils are the triglycerides of aliphatic fatty acids having between 10 and 25 carbon atoms. Still more preferred are the triglycerides of aliphatic fatty acids having from 16 to 20 carbon atoms. The most preferred triglycerides are triglycerides of C-18 fatty acids wherein at least one of the C-18 fatty acid units per triglyceride molecule contains at least one unit of ethylenic unsaturation. The most preferred triglyceride oils contain a plurality of units of ethylenic unsaturation per molecule. Non-limiting examples of highly preferred triglyceride oils include liquid vegetable oils such as linseed oil and soy oil. Soy oil is particularly preferred. An example of a commercial soy oil product is RBD SOYBEAN OIL, from Archer Daniels Midland Corporation. An example of a preferred grade of linseed oil is a dewaxed linseed oil. Dewaxed linseed oil compositions are known in the art and available commercially. Other dewaxed liquid vegetable oils may also be used as the triglyceride oil in the adhesive compositions of the invention. Dewaxed vegetable oils have been treated to remove most of the solid waxy impurities that are sometimes present in raw vegetable oil. A specific example of a dewaxed linseed oil product suitable for use in the process and compositions according to the invention is SUPERB linseed oil, which is commercially available from the Archer Daniels Midland Corporation. Crude linseed may also be used. Likewise, crude soybean oil may be used. A specific example of a crude linseed oil product that is suitable for use is “raw” linseed oil, which is commercially available from the Archer Daniels Midland Corporation. The liquid triglyceride oil most preferably has a viscosity (at 25° C.) which is less than the viscosity of Component A, with which it is to be blended (also measured at 25° C.). The blend of Component A with the triglyceride oil is most preferably lower than the viscosity of Component A itself (compared at 25° C.). The triglyceride oil is preferred to be substantially free of compounds that are not aliphatic triglycerides. By “aliphatic triglyceride” is meant a compound that contains at least one triglyceride unit, and preferably only one triglyceride unit, and is free of aromatic rings. By “substantially free” in this context it is meant that the triglyceride oil contains less than 20% by weight of non-triglyceride compounds, preferably less than 15% by weight, more preferably less than 10% by weight, still more preferably less than 5% by weight, most preferably less than 2% by weight, and ideally less than 1% by weight of non-triglyceride compounds. The preferred triglyceride oils may be used as diluents for monomeric (base) polyisocyanates and/or the final Component A comprising the isocyanate terminated prepolymers. The preferred triglyceride oils are non-toxic natural products that are substantially non-volatile and substantially free of offensive odors. Mixtures of different inert triglyceride oils may, of course, be used if desired.

The total level of the inert fatty ester component in the final adhesive composition (containing also the Component A, the particulate filler, and any other optional additives) is preferably in the range of from 1 to 30% by weight of the final adhesive composition. More preferably the level is from 2 to 25%, still more preferably from 3 to 20%, even more preferably from 4 to 15%, and most preferably from 5 to 12% of the final adhesive composition by weight.

Any suitable order of addition of the various ingredients, in forming the final adhesive composition is acceptable as long as it results in a processable adhesive composition. The more preferred blends are made from the polyisocyanate compositions comprising isocyanate terminated prepolymers (i.e. the final Component A).

Also, it may be desirable to utilize additional optional diluents and/or wetting agents in the final adhesive composition in order to modify the viscosity of the composition. These materials are used in amounts appropriate for specific applications that will be evident to one skilled in the art. Alkylene carbonates such as propylene carbonate may be particularly useful as an additive in some formulations. This inert and relatively high boiling compound can be useful for improving the stability of the final adhesive composition, with respect to separation. The optional additional additives, if used at all, should preferably be present at low levels. The level of all such optional additives combined is typically from 0 to less than 30% by weight of the final adhesive composition, but preferably from 0 to less than 25%, more preferably from 0 the less than 20%, still more preferably from 0 to less than 15%, even more preferably from 0 to less than 10%, and most preferably from 0 to less than 5% by weight of the final adhesive composition. The final adhesive compositions are preferably liquids at 25° C.

The viscosity of the final adhesive composition is preferably less than 12,000 cps at 25° C., more preferably less than 10,000 cps, still more preferably less than 7000 cps, even more preferably less than 5000 cps, and most preferably less than 4000 cps at 25° C. The compositions are further preferably stable with respect to bulk separation of the particulate filler, gel formation, and substantial increase in viscosity during storage under dry conditions at 25° C. The viscosity should not increase above usable levels, as indicated above, during storage.

It has been surprisingly found that the adhesive compositions according to the invention retain the excellent fast curing (and cold curing) properties of the prior art while exhibiting dramatically reduced tendency toward foaming during cure, in relation to the same adhesive compositions in the absence of the fatty ester and the particulate filler. The improved adhesives of the invention also have excellent gap filling characteristics. The adhesive compositions of the present invention have been found to have a pot life of approximately one month or more under moisture-free conditions prior to application to a substrate. The present compositions are also “cold curable”, and may be cured at a temperature of about 100° C. to about room temperature (25° C.) although they can also be hot cured (i.e. at temperatures greater than 100° C.) if desired. Thus, the present compositions may be cured at temperatures of from greater than about 100° C. to about 500° C. Preferably, the present compositions are cured at a temperature of about 23° C. to about 250° C. Generally, most systems will cure at room temperature in about 5 to 60 minutes.

The adhesive compositions may be used to bond many different types of moisture-containing substrates. Preferably, the adhesive compositions are used to bond multiple wood substrates together to prepare engineered lumber products. It is preferred that at least one of the substrates be selected from the group consisting of wood, paper, rice hulls, cement, stone, cloth, grass, corn husks, bagasse, nut shells, polymeric foam films and sheets, polymeric foams and fibrous materials. Preferably, the adhesive composition is used to fabricate multi-substrate composites or laminates, particularly those comprising lignocellulosic or cellulosic materials, such as wood or paper, to prepare products such as plywood, laminated veneer lumber (LVL), waferboard, particleboard, fiberboard, chipboard, and oriented wood products, such as PARALLAM products, available from McMillan Bloedell. Other applications include the manufacture of engineered structural wood composites such as I-beams (also known as I-joists), laminated beams, and the like, where the ability to cure the adhesive efficiently at relatively low temperatures and with reduced foaming are particularly important advantages.

As the adhesive compositions are moisture-activated, it is preferred that the substrates have a relatively high moisture content. Specifically, the substrates should have a moisture content of at least about 7% by weight. Preferably, the substrates have a moisture content of about 10 to 20% by weight and more preferably about 12 to 15% by weight. As contained herein, references to the moisture content of a substrate are expressed in terms of moisture content that is determined according to the following procedure. Particularly, to determine the moisture content of a substrate at any stage during the lumber production process a sample of the substrate is weighed and such weight is recorded as the “wet weight”. The sample is then placed into an oven and heated at temperatures not to exceed 217° F. (103° C.) until all of the moisture has been removed (the “oven dry weight”) and that weight is recorded. It can be determined that the oven-dry weight has been reached when, after weighing at various intervals, the sample stops losing weight. The oven-dry weight is then subtracted from the wet weight and the resultant is divided by the oven-dry weight. That resultant figure is then multiplied by 100 to determine the percentage of moisture content in the substrate.

When used in a preferred process to bond multiple substrates together, the adhesive compositions are applied to a surface of a first substrate. A surface of a second substrate is then contacted with the surface of the first substrate containing the adhesive composition. Pressure is then applied to the contacted surfaces and the adhesive compositions are allowed to cure. The surface of the second substrate against which the first substrate is contacted is generally not treated with the present adhesive composition. However, that surface may also be treated with the adhesive composition prior to contacting the substrates if desired.

The adhesive compositions may also be formulated to provide cold tack immediately after application to a substrate. This is particularly useful for pre-press operations where mechanical handling is often necessary. Cold tack may be accomplished by inclusion of about 10-20% by weight of a faster acting ethylenediamine-initiated polyol in Component A (relative to the weight of the final Component A formulation). Generally, the polyols most preferred for cold tack have a relatively high ethylene oxide content, i.e., greater than 25% by weight of the polyol, and are considered to be faster acting (i.e. to promote faster cure of the adhesive) than polyols with lower ethylene oxide content.

The adhesive compositions may be applied to the surfaces of the substrates in any conventional manner. For example, the surface may be treated with the composition by spraying, brushing, rolling, doctor blading, etc. Suitable means for applying the adhesive compositions to the surface of the substrate for a particular application will be evident to one skilled in the art.

After the adhesive treated substrates are contacted with each other, pressure is applied thereto. The pressure should be sufficient to cause the surfaces to adhere to one another. Generally, the amount of pressure and the time period for which the pressure is applied are not limited and specific pressures and times will be evident to one skilled in the art. However, it has been found preferable that a pressure of approximately 10 to 200 psi (0.70 to 14.1 kg/cm²) be applied for about 2 to about 20 minutes to cause appropriate adhesion for most substrates. Further processing can generally be conducted on the treated substrates in about one hour, or less.

It is to be understood that all molecular weights, equivalent weights, and functionalities herein for polymeric compounds are number averaged unless indicated otherwise; and that all molecular weights, equivalent weights, and functionalities for pure compounds are absolute unless indicated otherwise.

The invention is further illustrated by the following non-limiting examples.

### EXAMPLES

GLOSSARY:

1) LINESTAR™ 4605 adhesive: is a liquid moisture curable isocyanate resin composition derived from the reaction of a mixture of MDI series polyisocyanates with a combination of polyols, the combination of polyols consisting of greater than 10% by weight of an ethylene diamine initiated polyoxyethylene-polyoxypropylene polyol. The ethylene diamine initiated polyol contains greater than 1% by weight of oxyethylene units in its polyether structure. LINESTAR™ 4605 adhesive contains greater than 10% by weight of the ethylene diamine initiated polyether polyol. LINESTAR™ 4605 adhesive also contains a minor amount of an additional tertiary amine catalyst, separate from the amine initiated polyol ingredient. The tertiary amine catalyst is free of active hydrogen groups. This prepolymer modified isocyanate product has a free —NCO content of about 19% by weight and is available commercially from Huntsman Polyurethanes. LINESTAR™ 4605 adhesive is an example of an isocyanate functional prepolymer-containing composition suitable for use as Component A of the adhesive compositions according to the invention.
2) LINESTAR™ 4800 adhesive: is a liquid isocyanate resin which is very similar to LINESTAR™ 4605 adhesive, but does not contain any additional tertiary amine catalyst separate from the tertiary amine initiated polyol ingredient. This isocyanate product is also commercially available from Huntsman Polyurethanes, and is another example of an isocyanate-functional prepolymer-containing composition suitable for use as Component A of the adhesive compositions according to the invention.
3) Soy Oil: is alkali refined soybean oil, commercially available from Archer Daniels Midland Corporation. This soybean oil product is an example of an inert fatty ester composition, consisting essentially of fatty ester compounds containing at least 20 carbon atoms, suitable for use in the adhesive compositions according to the invention.
4) NICRON 604 filler: is a talc product (hydrous magnesium silicate, of 2.6 micron average particle diameter), commercially available from Luzenac America, Inc. This filler product is an example of a filler suitable for use in the adhesive compositions according to the invention.

### Example 1

### Comparative Effect of Diluents on Foaming and Viscosity

10 gram aliquots of a one-part moisture curable adhesive (LINESTAR™ 4605 adhesive from Huntsman Polyurethanes) were separately mixed in glass containers with 1%, 2%, 5%, and 10% (by weight, relative to the LINESTAR™ 4605 adhesive) soy oil, d-limonene (from Florida Chemical Company, Inc.), and JEFFSOL® propylene carbonate (from Huntsman Petrochemical Corporation), respectively, as shown in Table 1. The jars were sealed under nitrogen, and the samples were then mixed for approximately 10 minutes with a vortex mixer. The relative viscosity of each liquid mixture was qualitatively ranked based on visual comparison. 0.50 g of each sample was brushed separately onto the surfaces of 2″×2″ (5.08 cm×5.08 cm) blocks of southern yellow pine [SYP]. The samples were allowed to cure on the wood surfaces for approximately one hour under ambient conditions, after which the degree of foaming was ranked by qualitative visual comparison. Table 1 lists the compositions and Table 2 shows the qualitative ranking of viscosity from highest to lowest for the respective samples. Table 3 ranks the relative degree of foaming of the cured adhesives from highest to lowest.

TABLE 1
Compositions

| | | | Wt. % |
|---|---|---|---|
| Sample | Wt. % soy oil | Wt. % d-limonene | Propylene Carbonate |
| 1-1 | 0 | 0 | 0 |
| 1-2 | 1 | 0 | 0 |
| 1-3 | 2 | 0 | 0 |
| 1-4 | 5 | 0 | 0 |
| 1-5 | 10 | 0 | 0 |
| 1-6 | 0 | 1 | 0 |
| 1-7 | 0 | 5 | 0 |
| 1-8 | 0 | 10 | 0 |
| 1-9 | 0 | 0 | 1 |
| 1-10 | 0 | 0 | 2 |
| 1-11 | 0 | 0 | 5 |
| 1-12 | 0 | 0 | 10 |

TABLE 2
Qualitative viscosity ranking from highest to lowest

| | |
|---|---|
| High | 1-1 |
| | 1-2 = 1-6 = 1-9 |
| | 1-3 = 1-10 |
| | 1-4 = 1-7 = 1-11 |
| Low | 1-5 = 1-8 = 1-12 |

TABLE 3
Relative degree of foaming from highest to lowest

| | |
|---|---|
| High | 1-1 = 1-6 = 1-7 = 1-9 = 1-10 = 1-11 |
| | 1-2 = 1-8 = 1-12 |
| | 1-3 |
| | 1-4 |
| Low | 1-5 |

This data illustrates that the degree of foaming is strongly dependent on the choice of diluents. Even though all three diluents can lower the viscosity of the composition, the degree of degassing in the cured composition is greatest with soy. This illustrates that viscosity reduction alone is surprisingly not a sufficient condition for faster defoaming during the curing stage of the adhesive.

### Example 2

### Effect of Relative Viscosity on Foaming

Several aliquots of LINESTAR™ 4605 adhesive were mixed with soy oil at a ratio of 90 g to 10 g (sample 2-1) using the procedure described in Example 1. A second series of samples was prepared by adding talc (NICRON 604 hydrous magnesium silicate, 2.6 micron average particle size, Luzenac America, Inc.) at ratios of 10 g talc to 100 g 2-1, and 17.2 g talc to 100 g of 2-1 (samples 2-2 and 2-3 respectively). These samples were mixed by hand with a spatula, sealed in glass containers under dry nitrogen, hand shaken, heated to 65° C. for 1 hour, and then reagitated by hand until the talc was qualitatively well dispersed. The samples were then allowed to cool to room temperature. Each sample was brushed onto a separate block of SYP for qualitative comparison of foaming (using the procedure outlined in Example 1). The relative viscosities of the liquid adhesives were measured with a Brookfield viscometer at 25° C. using an LV #3 spindle at a shear rate of 12 rpm. Table 4 lists the relative viscosity of each formulation, while Table 5 shows the qualitative ranking of foaming from highest to lowest.

TABLE 4
Brookfield Viscosity of Comparative Formulations

| Sample | Viscosity (cps) |
|---|---|
| 1-1 LINESTAR ™ 4605 adhesive | 2869 |
| 2-1 LINESTAR ™ 4605 adhesive/soy | 1560 |
| 2-2 LINESTAR ™ 4605 adhesive/soy 10 talc | 1940 |
| 2-3 LINESTAR ™ 4605 adhesive/soy 17.2 talc | 3239 |

TABLE 5
Relative degree of foaming from highest to lowest

| | |
|---|---|
| High | 1-1 |
| Low | 2-1 = 2-2 = 2-3 |

One would anticipate that the efficiency of degassing should decrease with increasing viscosity. This data collectively shows that even though the addition of talc increases the viscosity, the degree of foaming in the cured formulations is surprisingly unaffected. Consequently, this enables the simultaneous achievement of low foam (which is a function of soy oil level), and viscosity control (which is a function of filler level). The added benefit of viscosity control means that the adhesive can be tailored to meet the process needs of various adhesive applications without affecting its low foaming characteristics.

### Example 3

### Effect of Additives on Cure Rate

In spite of its similar viscosity to sample 1-1, sample 2-3 was shown to provide surprisingly efficient defoaming characteristics as stated in Example 2. Given this surprising efficiency, one skilled in the art might hypothesize that the cure rate of 2-3 could be slower than the corresponding sample without soy and talc. A slower cure rate would translate to lower viscosity during the cure process, which in turn would facilitate the degassing of the resultant polymer. In order to test this hypothesis, Dynamic Mechanical Analysis (DMA) was used to follow the mechanical cure of samples 1-1 and 2-3 on a sample of sugar maple veneer. Surprisingly, the cure rate of the materials was found to be the same. This shows that the defoaming characteristics do not arise from a simple difference in the overall rate of cure.

Experimental Procedure and Analysis:

The DMA apparatus was set up in data collection mode at a fixed frequency of 1 Hz, and with no heater control (the furnace was open). This allowed the sample to be run at ambient temperature/humidity; thus eliminating concerns of drying due to nitrogen purge. The samples were prepared as follows. First, a blank set of veneers (a matched set based on grain pattern and location from veneer) was run for one hour to establish a baseline modulus for the wood itself. Second, the adhesive samples were prepared by using the same wood from the baseline experiment, and applying adhesive with a ½-inch paintbrush in the grain direction of the wood. Adhesive loadings between samples were maintained at 52 mg (+/− 1 mg). The coated wood veneer was then placed in the DMA to cure at ambient temperature. This was repeated for each of the two adhesives.

Because LINESTAR™ 4605 adhesive (resin 1-1) foams to a much greater extent than adhesive resin 2-3, the thickness of the cured samples were significantly different from each other, and from the starting thickness values at the onset of the experiments. Because the calculation of modulus depends on sample geometry (i.e., thickness), it was necessary to use the sample dimensions of the cured samples to approximate their plateau modulus values. It was found that adhesive resin 2-3 had a much higher plateau modulus (8160 MPa after 50 minutes of cure) than resin 1-1 (7270 MPa after 50 minutes of cure). A comparison of the change in modulus between 5 minutes and 50 minutes of cure for both samples shows that adhesive resin 2-3 has a greater change in modulus (5799 MPa) than the prior art resin 1-1 (5066 MPa). These differences were shown to be significant. The onset of gelation was the same for both samples.

A comparison of rate of cure was performed using the slope through the transition of the storage modulus curves (slope at the inflection between the gel point and the final plateau modulus). The rate of change was found to be statistically the same for both samples, 528 MPa/min for adhesive resin 2-3 and 549 MPa/min for prior art resin 1-1.

### Example 4

### Comparative Use of Formulations with and without Soy and Talc

Large Scale Preparation of an Inventive Adhesive Resin for Pilot Trials:

The adhesive resin in this Example is very similar to adhesive resin 2-3, except that a minor amount of CaO was pre-mixed with the primary filler (talc) in order to ensure the dryness of the latter filler. This adhesive resin is identified as 4-1. Large batches of adhesive resin 4-1 were made for I-Beam scale-up trials. Lymtal Inc. was contracted to make 550 pound batches of adhesive resin 4-1. The following are the ingredients used to form resin 4-1.

| Ingredient/Item | Percentage of Composition |
|---|---|
| 1.) NICRON 604 product | 11.8% |
| 2.) Quicklime (CaO) | 2.9% |
| 3.) Soy Oil | 8.5% |
| 4.) LINESTAR ™ 4605 adhesive | 76.8% |

Manufacturing Steps
1.) Items 1 and 2 were charged into a clean, dry 55-gallon (242 liter) drum and mixed well with an air mixer. This material was covered and allowed to sit for 24 hours to dehydrate.
2.) Water content of item 3 was checked and found to be 65.9 ppm (within the acceptable limit of <200 ppm).
3.) In a clean, dry reactor item 3 and half of item 4 (38.4%) were charged into the reactor and mixed. The temperature of the mixture was 75° F. (24° C.).
4.) The mixture in Step 1 was then added to the mixture in Step 3 and dispersed at high speed/shear until the slurry was smooth, while making sure that the temperature of the mixture did not exceed 85° F. (29° C.). A sample of this mixture was taken for measurement to determine grinding efficiency. The temperature of the mixture was 83° F. (28° C.) and the Hegman Grind was measured to be 0.5 mils (<1.0 mils is required). (The Hegman Grind Scale is a common scale in use for fillers in coatings and paints to indicate particle size or “fineness” of grind. This information was taken directly from the supplier's data sheet.)
5.) After the initial slurry was prepared, the second half of Item 4 was added and agitated at slow speed for 45 minutes under a vacuum to reduce air content. During this step, the temperature of the material was kept below 77° F. (25° C.). A sample of this material was taken for a relative viscosity measurement. The viscosity was 4400 cps @ 80° F. (27° C.).
6.) The material was passed through a 100-micron filter into a closed head 55-gallon (242 liter) metal drum, and was then flushed with nitrogen and sealed.
   A variation of this formulation is the use of LINESTAR™ 4800 adhesive instead of LINESTAR™ 4605 adhesive. LINESTAR™ 4800 adhesive may be used for laminated veneer lumber applications (See Example 5).
   Comparison of Formulations

I-beam samples were manufactured to test the performance of adhesive resin 4-1 vs. prior art resin 1-1. A series of experiments compared adhesive dosage (also known as spread rate) covering the range 5 lbs (2.27 kg) adhesive per 1000 linear ft. (305 meters) of I-beam to 15 lbs (6.80 kg) adhesive per 1000 linear ft (305 meters) of I-beam. The fit of the I-beam web-to-flange joint was also tested. The web-to-flange joint covered a flange grove range of −0.015 inches (−0.038 cm) to +0.030 inches (0.076 cm), where zero is a matching fit of the dimensions of the web cross-section and the flange grove. The two adhesives were applied via extrusion through a fitting into the flange of the I-beam.

The two adhesives were applied via extrusion through a fitting onto the flange of the I-beam. The I-beams were cut into samples 56 inches (142 cm) in length (containing no web-to-web joints). These samples were tested for shear strength using a Modified-Rail Test, ASTM designation D-4027. This test measures the shear modulus and shear strength of an adhesive between rigid adherends. Statistical analysis of 256 total beam samples showed that adhesive resin 4-1 and prior art resin 1-1 performed equally under all conditions except when the fit of the web-to-flange joint was “loose” (+0.03 inches (0.076 cm)) inventive adhesive resin 4-1 consistently yielded statistically greater performance as measured by the Ultimate Load to break the shear samples. This surprising finding can be attributed to the gap filling capability of this adhesive and the probable increase in material strength due to less foaming of the adhesive.

### Example 5

### Effect of Soy/Talc on a Slower Curing Formulation

The adhesive resin formulation in this example contains none of the optional non-isocyanate-reactive tertiary amine catalyst, which results in a slower cure rate. This adhesive resin is identified as 5-1. The slower cure rate can in turn be useful in certain wood laminate applications such as in the manufacture of laminated veneer lumber products for the composite wood products industry.

A sample of LINESTAR™ 4800 adhesive was mixed with soy oil and talc yielding the following composition:

| | |
|---|---|
| LINESTAR ™ 4800 adhesive | 76.8% |
| Soy Oil | 8.5% |
| NICRON 604 product | 14.7% |

This adhesive resin composition (5-1) was compared to the neat prior art resin LINESTAR™ 4800 adhesive to determine if a difference in foaming could be observed. 0.50 g of each sample was brushed separately onto the surfaces of 2″×2″ (5.08 cm×5.08 cm) blocks of southern yellow pine. The samples were allowed to cure on the wood surfaces for approximately one hour under ambient conditions, after which the degree of foaming was ranked by qualitative visual comparison. Although the overall cure rates were qualitatively slower than the corresponding cure rates for the samples in Examples 2 and 3, the sample with soy and talc (resin 5-1) provided significantly less foaming than the comparative sample (LINESTAR™ 4800 adhesive) with no soy and talc.

1. A moisture activated adhesive suitable for use in cold cure applications comprising:
a. an isocyanate functional reaction product of:
i. a monomeric organic polyisocyanate, and
ii. an isocyanate reactive component comprising at least one aliphatic tertiary amine initiated polyether polyol having an ethylene oxide content of at least 1% by weight relative to the total weight of the aliphatic tertiary amine initiated polyol;
b. an inert fatty ester compound that contains at least 20 carbon atoms; and
c. a dispersed inert filler;
wherein the moisture activated adhesive has a reduced tendency towards foaming during the cure thereof in the presence of moisture.

2. The moisture activated adhesive of claim 1, wherein the monomeric organic polyisocyanate has a number averaged isocyanate functionality of 2.0 or greater.

3. The moisture activated adhesive of claim 2, wherein the monomeric organic polyisocyanate comprises a polymeric diphenylmethane diisocyanate.

4. The moisture activated adhesive of claim 1, wherein the inert fatty ester compound comprises an inert triglyceride oil.

5. The moisture activated adhesive of claim 4, wherein the inert triglyceride oil comprises one or more triglycerides of aliphatic fatty acids having between 10 and 25 carbon atoms.

6. The moisture activated adhesive of claim 1, wherein the inert fatty ester compound comprises soybean oil or linseed oil.

7. The moisture activated adhesive of claim 1, wherein the dispersed inert filler comprises one or more members selected from the group consisting of powdered inorganic silicates, powdered silica, powdered calcium carbonate, and powdered calcium oxide.

8. The moisture activated adhesive of claim 1, wherein the dispersed inert filler comprises talc and calcium oxide.

9. A moisture activated adhesive suitable for use in cold cure applications comprising:
a. an isocyanate functional reaction product of:
i. a monomeric organic polyisocyanate, and
ii. an isocyanate reactive component comprising at least 10% by weight of at least one aliphatic tertiary amine initiated polyether polyol having an ethylene oxide content of at least 1% by weight relative to the total weight of the aliphatic tertiary amine initiated polyol;
b. from 3 to 20% by weight of one or more inert fatty ester compounds each containing at least 20 carbon atoms; and
c. from 5 to 20% by weight of at least one dispersed inert filler;
wherein the moisture activated adhesive has a reduced tendency towards foaming during the cure thereof in the presence of moisture.

10. The moisture activated adhesive of claim 9, wherein the monomeric organic polyisocyanate has a number averaged isocyanate functionality of 2.0 or greater.

11. The moisture activated adhesive of claim 10, wherein the monomeric organic polyisocyanate comprises a polymeric diphenylmethane diisocyanate.

12. The moisture activated adhesive of claim 9, wherein the one or more inert fatty ester compounds comprise an inert triglyceride oil.

13. The moisture activated adhesive of claim 12, wherein the inert triglyceride oil comprises one or more triglycerides of aliphatic fatty acids having between 10 and 25 carbon atoms.

14. The moisture activated adhesive of claim 9, wherein the one or more inert fatty ester compounds comprises soybean oil, linseed oil, or mixtures thereof.

15. The moisture activated adhesive of claim 9, wherein the dispersed inert filler comprises one or more members selected from the group consisting of powdered inorganic silicates, powdered silica, powdered calcium carbonate, and powdered calcium oxide.

16. The moisture activated adhesive of claim 9, wherein the at least one dispersed inert filler comprises talc and calcium oxide.

17. A bonded article comprising at least one moisture containing substrate and an adhesive, wherein the adhesive comprises:
a. an isocyanate functional reaction product of:
i. a monomeric organic polyisocyanate, and
ii. an isocyanate-reactive component comprising at least one aliphatic tertiary amine-initiated polyether polyol having an ethylene oxide content of at least 1% by weight relative to the total weight of the aliphatic tertiary amine-initiated polyol;
b. an inert fatty ester compound that contains at least 20 carbon atoms; and
c. a dispersed inert filler;
wherein the adhesive has a reduced tendency towards foaming during the cure thereof in the presence of moisture.

18. The bonded article of claim 17, wherein the at least one substrate comprises a lignocellulosic material, a cellulosic material, or combinations thereof.

19. A process for bonding multiple substrates comprising the steps of:
a. applying to a surface of at least one substrate a moisture activated adhesive composition that comprises:
i. an isocyanate functional reaction product of:
a. a monomeric organic polyisocyanate, and
b. an isocyanate-reactive component comprising at least one aliphatic tertiary amine-initiated polyether polyol having an ethylene oxide content of at least 1% by weight relative to the total weight of the aliphatic tertiary amine-initiated polyol;
c. an inert fatty ester compound that contains at least 20 carbon atoms; and
d. a dispersed inert filler;
wherein the adhesive has a reduced tendency towards foaming during the cure thereof in the presence of moisture;
b. contacting the surface of the at least one substrate with a surface of a second substrate;
c. applying pressure to the contacted surfaces; and
d. causing the adhesive composition to cure and form an adhesive bond between the substrates.

20. The process of claim 19, wherein the substrates have a moisture content of at least about 7% by weight.

21. The process of claim 20, wherein at least one substrate comprises a lignocellulosic material or a cellulosic material.
